(19) United States
(12) Patent Application Publication
(10) Pub. No.: US 2018/0271063 A1
(43) Pub. Date: Sep. 27, 2018

(54) METHOD FOR MAKING A REINFORCED ELASTOMER AND A PET PRODUCT MADE FROM SAME

(71) Applicant: HT Pet Products, LLC, El Paso, TX (US)

(72) Inventor: Henry Ho, Shanghai (CN)

(21) Appl. No.: 15/925,233

(22) Filed: Mar. 19, 2018

Related U.S. Application Data
(60) Provisional application No. 62/474,329, filed on Mar. 21, 2017.

(51) Int. Cl. A01K 15/02; C08L 21/00; C08L 27/06; C08J 5/04; C08K 3/22; C08K 3/26; C08K 3/04; C08L 3/02; C08L 83/04

(52) U.S. Cl. CPC A01K 15/026; C08L 21/00; C08L 27/06; C08J 5/04; C08K 3/22; C08K 3/26; C08K 2003/265; C08L 3/02; C08L 83/04; C08J 2300/26; C08J 2300/22; C08K 2003/2296; C08K 3/04

(57) ABSTRACT

A process of making a reinforced elastomer and toy for pet made from same. The elastomer body may include rubber, thermoplastic resin, and elastomeric polyvinyl chloride. The elastomeric material is reinforced with fibers. Flavoring agents are mixed in the elastomeric body to produce a compression resistant and long-lasting scented body with durable fragrance. The fibers may be bonded to an outer surface of the elastomeric material.

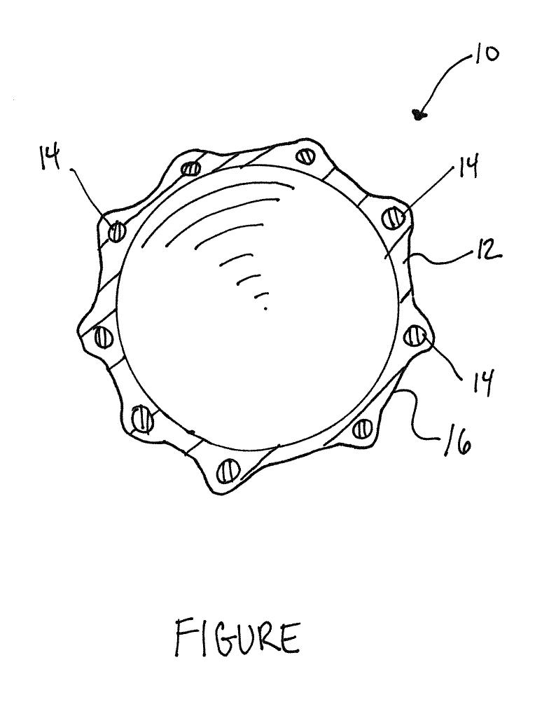

### RELATED APPLICATIONS

This application claims priority to U.S. Provisional Patent Application No. 62/474,329 filed on Mar. 21, 2017, the entirety of which is incorporated by reference.

### FIELD OF THE INVENTION

The present invention relates to a pet product, in particular a compression resistant and long-lasting scented dog toy, and more specifically to a method for making reinforced elastomer used to produce such a pet product.

### BACKGROUND OF THE INVENTION

Many people raise pets, among which dogs are the most popular. To improve the quality of life for pets, there are many options for food, toys, and medicine specifically developed for pets. It is believed to be important to generate interactions between dogs and people so as to cultivate a bond and provide dogs with free to play time. One common way that people typically interact with dogs is with a game of “fetch,” wherein a person throws an object and the dog retrieves the object.

Traditionally small objects such as flying discs, shoes, and baseballs, bones or bone-shaped objects serve as the item for dogs to pick up. Many of these objects for dogs are made of rubber, while others are made with a layer of fabric and sponge and are not resilient to compression or bites.

With respect to rubber objects, traditional rubber toys are produced via an injection molding. However, such processes may not be desirable for all applications. Additionally, for the rubber objects, once the surface of the rubber object is penetrated, intentionally or unintentionally, the resulting aperture is typically a point of weakness in the rubber. The rubber object typically tends to break apart as a result of the penetration.

Moreover, many currently available dog-biting toys are usually free of flavor. Some individual products are covered with a small amount of spice on the surface, but the spice soon evaporates and is not retained for a long or extended period of time.

Accordingly, there is a need for developing an improved material for producing object for pets, as well as method of making such a material and objects that addresses one or more of the above-identified drawbacks.

### SUMMARY OF THE INVENTION

The above-mentioned need is met or exceeded by the present disclosure, specifically the processes and apparatus described herein.

Accordingly, the present invention provides a reinforced elastomer material. The elastomer material is reinforced with fibers.

In an aspect, the present disclosure provides a process for making a reinforced elastomer comprising: at least partially manufacturing elastomer; applying fibers to a surface of the elastomer; and, bonding the fibers to the elastomer. The fibers may be bonded by being made or formed into a composite with the elastomer. By applying fibers, it is meant that the fibers may be laid on the elastomer or otherwise brought into contact with the elastomer.

In another aspect, the present disclosure provides a compression resistant and long-lasting scented dog toy with simple structure and durable fragrance. The compression resistant and long-lasting scented dog toy includes a body formed from a reinforced elastomer. The elastomer is formed from the following raw materials by weight: 40-60 parts natural rubber, 1-3 parts zinc oxide, 2-4 parts camphene, 20-25 parts stearic acid, 1-2 parts anti-aging agent, 1-5 parts edible gum, 15-20 parts starch, 3-5 parts microcrystalline wax, 1-3 parts white carbon black, 15-25 parts naphthenic oil, 10-15 parts silicone rubber, 3-5 parts butyl rubber, 0.3-0.7 parts accelerant, 0.1-0.3 parts antioxidant, 2-4 parts medical light calcium carbonate, 3-5 parts edible rapeseed oil, 4-6 parts flavor enhancer, 0.4-0.6 parts sour agent, 15-20 parts talcum powder, and 3-5 parts fatty acid softening agent.

It is further contemplated that the elastomer is formed from, by weight: 45-55 parts natural rubber, 1.5-2.5 parts zinc oxide, 2.5-3.5 parts camphene, 21-24 parts stearic acid, 1.2-1.8 parts anti-aging agent, 2-4 parts edible gum, 16-19 parts starch, 3.5-4.54 parts microcrystalline wax, 1.5-2.5 parts white carbon black, 18-22 parts naphthenic oil, 11-14 parts silicone rubber, 3.5-4.5 parts butyl rubber, 0.4-0.6 parts accelerant, 0.15-0.25 parts antioxidant, 2.5-3.5 parts medical light calcium carbonate, 3.5-4.5 parts edible rapeseed oil, 4.5-5.5 parts flavor enhancer, 0.45-0.55 parts sour agent, 16-19 parts talcum powder, and 3.5-4.5 parts fatty acid softening agent.

It is further contemplated that the elastomer is formed from, by weight: 50 parts natural rubber, 2 parts zinc oxide, 3 parts camphene, 22 parts stearic acid, 1.5 parts anti-aging agent, 2 parts edible gum, 18 parts starch, 4 parts microcrystalline wax, 2 parts white carbon black, 20 parts naphthenic oil, 12 parts silicone rubber, 4 parts butyl rubber, 0.5 parts accelerant, 0.2 parts antioxidant, 3 parts medical light calcium carbonate, 4 parts edible rapeseed oil, 5 parts flavor enhancer, 0.5 parts sour agent, 18 parts talcum powder, and 4 parts fatty acid softening agent.

The materials forming the elastomer body may be mixed and formed into a semi-finished body. A plurality of fibers, including for example a fabric, is applied to a surface to the semi-finished elastomer body. The fibers are bonded to the semi-finished elastomer body. Both natural and synthetic fibers are contemplated, for example polypropylene fibers, nylon fibers, including unwoven and woven, for example nylon oxford. Exemplary elastomer materials include rubbers, both natural and synthetic, thermoplastic resins, and elastomeric polyvinyl chloride.

Once the fibers are bonded to the semi-finished elastomeric body to form reinforced elastomeric, the reinforced elastomeric may be re-shaped and cut to form the toy. The toy may be formed by stitching, or otherwise connecting, together different parts formed from the reinforced elastomer. Unlike current rubber toys, the reinforced elastomer will resist breaking apart proximate the punctures associated with the stitching. Additionally, the fibers provide the surface of the reinforced elastomer, and the toy, with a rough texture (i.e., meaning marked by inequalities, ridges, or projections on the surface).

It is further contemplated that the flavor enhancer is ethyl maltol, vanillin or fruity essence.

It is also contemplated that the sour agent is citric acid or malic acid.

Additional aspects, embodiments, and details of the present disclosure, all of which may be combinable in any manner, are set forth in the following detailed description of the disclosure.

### BRIEF DESCRIPTION OF THE DRAWINGS

One or more exemplary embodiments of the present disclosure will be described below in conjunction with the following drawing figures, in which:

The FIGURE shows a side cut-away view of a toy product according to one or more embodiments of the present invention.

### DETAILED DESCRIPTION OF EMBODIMENTS

With these general principles in mind, one or more embodiments of the present disclosure will be described with the understanding that the following detailed description is not intended to be limiting.

As shown in the FIGURE, a toy product 10 according to the present disclosure is made of an elastomer body 12 reinforced with fibers 14. Flavoring agents are mixed in the elastomer body so as to produce a compression resistant and long-lasting scented body. In addition, fibers 14 on an outer surface 16 of the body 12 enhance the firmness and tearing resistance of the toy product 10. The fibers 14 also attract a dog's attention for playing. The body 12 is made of, for example, natural rubber which is characterized in high resilience so as to attract the dog to chase and make the dog get enough exercise through continual bouncing after being thrown out. Other materials may be used including, synthetic rubber, PVC, and thermoplastic resins. Additionally, although depicted as a round ball, the elastomer body 12 may have any suitable shape for a toy product 10.

The aspects and embodiments of the present invention are described in detail in the following embodiments with the understanding that these embodiments are not intended to be limiting.

### Embodiment 1

A compression resistant and long-lasting scented dog toy includes a reinforced elastomeric body. The reinforced elastomeric body is made of following raw materials by weight: 40 parts natural rubber, 1 part zinc oxide, 2 parts camphene, 20 parts stearic acid, 1 part anti-aging agent, 1 part edible gum, 15 parts starch, 3 parts microcrystalline wax, 1 part white carbon black, 15 parts naphthenic oil, 10 parts silicone rubber, 3 parts butyl rubber, 0.3 parts accelerant, 0.1 parts antioxidant, 2 parts medical light calcium carbonate, 3 parts edible rapeseed oil, 4 parts flavor enhancer, 0.4 parts sour agent, 15 parts talcum powder and 3 parts fatty acid softening agent.

The preparation method of the compression resistant and long-lasting scented dog toy comprises following steps.

(1) Measure each raw material by specified weight.

(2) Add the zinc oxide, the microcrystalline wax, the white carbon black, the naphthenic oil, the medical light calcium carbonate and the edible rapeseed oil into a mixer and then mix them 20 min at a speed of 45 rpm to obtain the prepared auxiliary material.

(3) Put the natural rubber, the silicone rubber and the butyl rubber into an internal mixer for uniform mixing at a mixing temperature of 60° C. and a speed of internal mixer of 40 rpm. Once the material temperature increases to 85° C., add the prepared auxiliary material, the camphene, the stearic acid, the edible gum, the talcum powder and the fatty acid softening agent for mixing 6 min. After that, add the starch for uniform mixing and then discharge the prepared material at a temperature of 120° C.

(4) Add the anti-aging agent, the accelerant, the antioxidant, the flavor enhancer and the sour agent for mixing 4 min at a reaction temperature of 140° C.

(5) Once the prepared material is arranged to specified shape, use existing fluidization process to produce rubber for the elastomeric material.

(6) Fibers are bonded to a surface of the elastomeric material to provided reinforced elastomeric material.

### Embodiment 2

A compression resistant and long-lasting scented dog toy includes a semi-finished reinforced elastomeric body. The reinforced elastomeric body is made of following raw materials by weight: 45 parts natural rubber, 1.5 parts zinc oxide, 2.5 parts camphene, 21 parts stearic acid, 1.2 parts anti-aging agent, 2 parts edible gum, 16 parts starch, 3.5 parts microcrystalline wax, 1.5 parts white carbon black, 18 parts naphthenic oil, 11 parts silicone rubber, 3.5 parts butyl rubber, 0.4 parts accelerant, 0.15 parts antioxidant, 2.5 parts medical light calcium carbonate, 3.5 parts edible rapeseed oil, 4.5 parts flavor enhancer, 0.45 parts sour agent, 16 parts talcum powder, and 3.5 parts fatty acid softening agent.

The preparation method of the compression resistant and long-lasting scented dog toy comprises following steps.

(1) Measure each raw material by specified weight.

(2) Add the zinc oxide, the microcrystalline wax, the white carbon black, the naphthenic oil, the medical light calcium carbonate and the edible rapeseed oil into a mixer and then mix them 22 min at a speed of 50 rpm to obtain the prepared auxiliary material.

(3) Put the natural rubber, the silicone rubber and the butyl rubber into an internal mixer for uniform mixing at a mixing temperature of 65° C. and a speed of internal mixer of 42 rpm. Once the material temperature increases to 88° C., add the prepared auxiliary material, the camphene, the stearic acid, the edible gum, the talcum powder and the fatty acid softening agent for mixing 7 min. After that, add the starch for uniform mixing and then discharge the prepared material at a temperature of 122° C.

(4) Add the anti-aging agent, the accelerant, the antioxidant, the flavor enhancer and the sour agent for mixing 5 min at a reaction temperature of 141° C. Once the prepared material is arranged to specified shape, use the existing fluidization process to produce the elastomeric material.

(5) Fibers are bonded to the elastomeric material to form the semi-finished reinforced elastomeric body.

(6) The semi-finished reinforced elastomeric body is shaped to form the toy, which may be filled with additional fibers.

### Embodiment 3

The compression resistant and long-lasting scented dog toy includes a reinforced elastomeric body. Fibers are bonded to an outside of the elastomeric body. The elastomeric body is made of following raw materials by weight: 50 parts natural rubber, 2 parts zinc oxide, 3 parts camphene, 22 parts stearic acid, 1.5 parts anti-aging agent, 2 parts edible gum, 18 parts starch, 4 parts microcrystalline wax, 2 parts white carbon black, 20 parts naphthenic oil, 12 parts silicone rubber, 4 parts butyl rubber, 0.5 parts accelerant, 0.2 parts antioxidant, 3 parts medical light calcium carbonate, 4 parts edible rapeseed oil, 5 parts flavor enhancer, 0.5 parts sour agent, 18 parts talcum powder, and 4 parts fatty acid softening agent.

The preparation method of the compression resistant and long-lasting scented dog toy comprises following steps.

(1) Measure each raw material by specified weight.

(2) Add the zinc oxide, the microcrystalline wax, the white carbon black, the naphthenic oil, the medical light calcium carbonate and the edible rapeseed oil into a mixer and then mix them 25 min at a speed of 55 rpm to obtain the prepared auxiliary material.

(3) Put the natural rubber, the silicone rubber and the butyl rubber into an internal mixer for uniform mixing at a mixing temperature of 70° C. and a speed of internal mixer of 45 rpm. Once the material temperature increases to 90° C., add the prepared auxiliary material, the camphene, the stearic acid, the edible gum, the talcum powder and the fatty acid softening agent for mixing 8 min. After that, add the starch for uniform mixing and then discharge the prepared material at a temperature of 125° C.

(4) Add the anti-aging agent, the accelerant, the antioxidant, the flavor enhancer and the sour agent for mixing 6min at a reaction temperature of 142° C. Once the prepared material is arranged to specified shape, use the existing fluidization process to produce the elastomeric body.

(5) Fibers are bonded onto the outer surface of the elastomeric body to form the reinforced elastomeric body.

### Embodiment 4

The compression resistant and long-lasting scented dog toy includes an elastomeric body reinforced with fibers. The fibers are bonded to at least an outside surface the elastomeric body. The elastomeric body is made of following raw materials by weight: 55 parts natural rubber, 2.5 parts zinc oxide, 3.5 parts camphene, 24 parts of stearic acid, 1.8 parts anti-aging agent, 4 parts edible gum, 19 parts starch, 4.54 parts microcrystalline wax, 2.5 parts white carbon black, 22 parts naphthenic oil, 14 part silicone rubber, 4.5 parts butyl rubber, 0.6 parts accelerant, 0.25 parts antioxidant, 3.5 parts medical light calcium carbonate, 4.5 parts edible rapeseed oil, 5.5 parts flavor enhancer, 0.55 parts sour agent, 19 parts talcum powder, and 4.5 parts fatty acid softening agent.

The preparation method of the compression resistant and long-lasting scented dog toy comprises following steps.

(1) Measure each raw material by specified weight.

(2) Add the zinc oxide, the microcrystalline wax, the white carbon black, the naphthenic oil, the medical light calcium carbonate and the edible rapeseed oil into a mixer and then mix them 28 min at a speed of 60 rpm to obtain the prepared auxiliary material.

(3) Put the natural rubber, the silicone rubber and the butyl rubber into an internal mixer for uniform mixing at a mixing temperature of 75° C. and a speed of internal mixer of 48 rpm. Once the material temperature increases to 92° C., add the prepared auxiliary material, the camphene, the stearic acid, the edible gum, the talcum powder and the fatty acid softening agent for mixing 9 min. After that, add the starch for uniform mixing and then discharge the prepared material at a temperature of 128° C.

(4) Add the anti-aging agent, the accelerant, the antioxidant, the flavor enhancer and the sour agent for mixing 7min at a reaction temperature of 144° C. Once the prepared material is arranged to specified shape, use the existing fluidization process to produce the rubber body.

(5) Fibers are applied to an outer surface of the elastomeric body and bonded to the elastomeric body.

### Embodiment 5

The compression resistant and long-lasting scented dog toy includes an elastomeric body reinforced with fibers. The fibers are bonded to at least an outside surface the elastomeric body. The elastomeric body is made of following raw materials by weight: 60 parts natural rubber, 3 parts zinc oxide, 4 parts camphene, 25 parts stearic acid, 2 parts anti-aging agent, 5 parts edible gum, 20 parts starch, 5 parts microcrystalline wax, 3 parts white carbon black, 25 parts naphthenic oil, 15 parts silicone rubber, 5 parts butyl rubber, 0.7 parts accelerant, 0.3 parts antiozonant, 4 parts medical light calcium carbonate, 5 parts edible rapeseed oil, 6 parts flavor enhancer, 0.6 parts sour agent, 20 parts talcum powder, and 5 parts fatty acid softening agent.

The preparation method of the compression resistant and long-lasting scented dog toy comprises following steps.

(1) Measure each raw material by specified weight.

(2) Add the zinc oxide, the microcrystalline wax, the white carbon black, the naphthenic oil, the medical light calcium carbonate and the edible rapeseed oil into a mixer and then mix them 30 min at a speed of 65 rpm to obtain the prepared auxiliary material.

(3) Put the natural rubber, the silicone rubber and the butyl rubber into an internal mixer for uniform mixing at a mixing temperature of 80° C. and a speed of internal mixer of 50 rpm. Once the material temperature increases to 95° C., add the prepared auxiliary material, the camphene, the stearic acid, the edible gum, the talcum powder and the fatty acid softening agent for mixing 10 min. After that, add the starch for uniform mixing and then discharge the prepared material at a temperature of 130° C.

(4) Add the anti-aging agent, the accelerant, the antioxidant, the flavor enhancer and the sour agent for mixing 8min at a reaction temperature of 145° C. Once the prepared material is arranged to specified shape, use the existing fluidization process to produce the elastomeric body.

(5) Fibers are applied to an outer surface of the elastomeric body and bonded to the elastomeric body.

In any of the foregoing embodiments, the flavor enhancer may be ethyl maltol, vanillin, fruity essence, or mixtures thereof. The sour agent may be citric acid, malic acid, or mixtures thereof.

According to some aspects of the present invention flavoring agents are mixed in to the elastomeric body so as to produce a compression resistant and long-lasting scented body. In addition, the fabric covering the surface of upper ball can attract dog's attention for playing. In embodiments in which the elastomeric material is made of natural rubber, the product is characterized by its high resilience so as to attract the dog to chase it and get enough exercise through continual bouncing after it is thrown.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure, it being understood that various changes may be made in the function and arrangement of elements described in an exemplary embodiment without departing from the scope of the disclosure.

Claimed is:

1. A process for making a reinforced pet toy, the process comprising:
at least partially manufacturing an elastomer;
applying fibers to a surface of the elastomer; and,
bonding the fibers to the elastomer.

2. The process of claim 1, wherein the elastomer comprises, by weight: 40-60 parts natural rubber, 1-3 parts zinc oxide, 2-4 parts camphene, 20-25 parts stearic acid, 1-2 parts anti-aging agent, 1-5 parts edible gum, 15-20 parts starch, 3-5 parts microcrystalline wax, 1-3 parts white carbon black, 15-25 parts naphthenic oil, 10-15 parts silicone rubber, 3-5 parts butyl rubber, 0.3-0.7 parts accelerant, 0.1-0.3 parts antioxidant, 2-4 parts medical light calcium carbonate, 3-5 parts edible rapeseed oil, 4-6 parts flavor enhancer, 0.4-0.6 parts sour agent, 15-20 parts talcum powder, and 3-5 parts fatty acid softening agent.

3. The process of claim 2, wherein the flavor enhancer is selected from the group consisting of: ethyl maltol, vanillin, fruity essence, and mixtures thereof.

4. The process of claim 2, wherein the sour agent is selected from the group consisting of: citric acid, malic acid, and a mixture thereof.

5. The process of claim 2, wherein the step of at least partially manufacturing the elastomer comprises:
measuring one or more raw materials by specified weight;
adding the zinc oxide, the microcrystalline wax, the white carbon black, the naphthenic oil, the medical light calcium carbonate and the edible rapeseed oil into first a mixer and then mixing for 20-30 min at a speed of 45-65 rpm to obtain a prepared auxiliary material;
adding the natural rubber, the silicone rubber, and the butyl rubber into a second mixer for being operated at a mixing temperature of 60-80° C. and with a mixing speed of 40-50 rpm;
when the temperature of the second mixer reaches 85-95° C., adding the prepared auxiliary material, the camphene, the stearic acid, the edible gum, the talcum powder and the fatty acid softening agent and for mixing for 6-10 min;
adding the starch;
discharging a material at a temperature of 120-130° C.;
adding the anti-aging agent, the accelerant, the antioxidant, the flavor enhancer and the sour agent and mixing for 4-8 min at a reaction temperature of 140-145° C.; and,
then manufacturing the elastomer.

6. The process of claim 5, wherein the elastomer is manufactured in a fluidization process.

7. The process of claim 1, wherein the elastomer comprises, by weight: 45-55 parts natural rubber, 1.5-2.5 parts zinc oxide, 2.5-3.5 parts camphene, 21-24 parts stearic acid, 1.2-1.8 parts anti-aging agent, 2-4 parts edible gum, 16-19 parts starch, 3.5-4.54 parts microcrystalline wax, 1.5-2.5 parts white carbon black, 18-22 parts naphthenic oil, 11-14 parts silicone rubber, 3.5-4.5 parts butyl rubber, 0.4-0.6 parts accelerant, 0.15-0.25 parts antioxidant, 2.5-3.5 parts medical light calcium carbonate, 3.5-4.5 parts edible rapeseed oil, 4.5-5.5 parts flavor enhancer, 0.45-0.55 parts sour agent, 16-19 parts talcum powder and 3.5-4.5 parts fatty acid softening agent.

8. The process of claim 7, wherein the flavor enhancer is selected from the group consisting of: ethyl maltol, vanillin, fruity essence, and mixtures thereof.

9. The process of claim 7, wherein the sour agent is selected from the group consisting of: citric acid, malic acid, and a mixture thereof.

10. The process of claim 7, wherein the step of at least partially manufacturing elastomer comprises:
measuring one or more raw materials by specified weight;
adding the zinc oxide, the microcrystalline wax, the white carbon black, the naphthenic oil, the medical light calcium carbonate and the edible rapeseed oil into first a mixer and then mixing for 20-30 min at a speed of 45-65 rpm to obtain a prepared auxiliary material;
adding the natural rubber, the silicone rubber, and the butyl rubber into a second mixer for being operated at a mixing temperature of 60-80° C. and with a mixing speed of 40-50 rpm;
when the temperature of the second mixer reaches 85-95° C., adding the prepared auxiliary material, the camphene, the stearic acid, the edible gum, the talcum powder and the fatty acid softening agent and for mixing for 6-10 min;
adding the starch;
discharging a material at a temperature of 120-130° C.;
adding the anti-aging agent, the accelerant, the antioxidant, the flavor enhancer and the sour agent and mixing for 4-8 min at a reaction temperature of 140-145° C.; and,
then manufacturing the elastomer.

11. The process of claim 10, wherein the elastomer is manufactured in a fluidization process.

12. The process of claim 1, wherein the elastomer comprises, by weight: 50 parts natural rubber, 2 parts zinc oxide, 3 parts camphene, 22 parts stearic acid, 1.5 parts anti-aging agent, 2 parts edible gum, 18 parts starch, 4 parts microcrystalline wax, 2 parts white carbon black, 20 parts naphthenic oil, 12 parts silicone rubber, 4 parts butyl rubber, 0.5 parts accelerant, 0.2 parts antioxidant, 3 parts medical light calcium carbonate, 4 parts edible rapeseed oil, 5 parts flavor enhancer, 0.5 parts sour agent, 18 parts talcum powder and 4 parts fatty acid softening agent.

13. The process of claim 11, wherein the flavor enhancer is selected from the group consisting of: ethyl maltol, vanillin, fruity essence, and mixtures thereof.

14. The process of claim 11, wherein the sour agent is selected from the group consisting of: citric acid, malic acid, and a mixture thereof.

15. The process of claim 11, wherein the step of at least partially manufacturing elastomer comprises:
measuring one or more raw materials by specified weight;
adding the zinc oxide, the microcrystalline wax, the white carbon black, the naphthenic oil, the medical light calcium carbonate and the edible rapeseed oil into first a mixer and then mixing for 20-30 min at a speed of 45-65 rpm to obtain a prepared auxiliary material;
adding the natural rubber, the silicone rubber, and the butyl rubber into a second mixer for being operated at a mixing temperature of 60-80° C. and with a mixing speed of 40-50 rpm;
when the temperature of the second mixer reaches 85-95° C., adding the prepared auxiliary material, the camphene, the stearic acid, the edible gum, the talcum powder and the fatty acid softening agent and for mixing for 6-10 min;
adding the starch;
discharging a material at a temperature of 120-130° C.;
adding the anti-aging agent, the accelerant, the antioxidant, the flavor enhancer and the sour agent and mixing for 4-8 min at a reaction temperature of 140-145° C.; and,
then manufacturing the elastomer.

16. The process of claim 15, wherein the elastomer is manufactured in a fluidization process.

17. A compression resistant and long-lasting scented dog toy comprising:
an elastomeric body reinforced with fibers.

18. The compression resistant and long-lasting scented dog toy of claim 17 wherein the fibers provide an outer surface of the elastomeric body with a rough texture.

19. The compression resistant and long-lasting scented dog toy of claim 18 wherein, the elastomeric body is formed from a material selected from a group consisting of: rubber, polyvinyl chloride, and thermal plastic resin.

20. The compression resistant and long-lasting scented dog toy of claim 18 further comprising: a flavor enhancer incorporated in the elastomeric body.
